(19) United States
(12) Patent Application Publication
(10) Pub. No.: US 2025/0264780 A1
(43) Pub. Date: Aug. 21, 2025

(54) METHOD FOR OPERATING A PHOTO BOOTH, AND PHOTO BOOTH

(71) Applicant: KRUU GmbH, Bad Friedrichshall (DE)

(72) Inventor: Oliver Carlos GRÜNBERG, Bad Friedrichshall (DE)

(73) Assignee: KRUU GmbH, Bad Friedrichshall (DE)

(21) Appl. No.: 19/055,156

(22) Filed: Feb. 17, 2025

(30) Foreign Application Priority Data
Feb. 20, 2024 (EP) 24 158 645.2

(51) Int. Cl. G03B 15/05; H05B 45/10

(52) U.S. Cl. CPC G03B 15/05; H05B 45/10; G03B 2215/0503; G03B 2215/0567

(57) ABSTRACT

A method for operating a portable photo booth, wherein the portable photo booth comprises a housing, a camera, and a light-emitting diode array which comprises a plurality of individually controllable light-emitting diodes, wherein the light-emitting diode array is controlled according to a control instruction in such a way that the light-emitting diode array at least temporarily assumes a lighting state in which the brightness of at least one first light-emitting diode of the light-emitting diodes differs from the brightness of at least one second light-emitting diode of the light-emitting diodes. The invention also relates to a portable photo booth.

### CROSS-REFERENCE TO RELATED APPLICATIONS

This application claims priority to EP Patent Application No. 24 158 645.2 filed on Feb. 20, 2024, the entire contents of which are hereby incorporated by reference.

### DESCRIPTION

The present invention relates to the technical field of photography. In particular, the present invention relates to a photo booth and to a method for operating a photo booth.

A photo booth in the present context is a photography device that is usually used in a freestanding configuration. A photo booth usually has a stand that is attached or can be attached to the housing of the photo booth. A photo booth can, however, also be used without a stand. For this purpose, the photo booth can be placed for example on a table or another surface. A photo booth can in particular be portable, this meaning that the photo booth can be transported by a person manually and without mechanical aids, such as a hand truck or a forklift. It is also possible to take pictures while carrying the photo booth, at least with some photo booths. However, a photo booth in the present context does not mean a handheld consumer camera.

Photo booths are becoming increasingly popular at celebrations such as weddings. They make it possible for a photographer not necessarily to have to be present to take pictures. Rather, a user and/or a group of users can position themselves in front of the photo booth and take pictures with the photo booth on their own.

Such a photo booth is known from the utility model DE 20 2018 101 019 U1, for example. The photo booth comprises a housing in which a camera is arranged. The photo booth also comprises a light-emitting diode array that is arranged on the photo booth in such a way that a capture area of the camera can be illuminated by the light-emitting diode array.

The invention relates to the object of improving the user experience of a photo booth.

According to the invention, for this purpose a method for operating a photo booth with the features of claim 1 is provided.

The photo booth comprises a housing in which a camera is arranged. The camera is directed at a capture area outside the housing. The camera can be, for example, a USB camera, a system camera, an industrial camera or a compact camera. The photo booth also comprises a light-emitting diode array that is arranged in or on the housing in such a way that the capture area can be illuminated by the light-emitting diode array. The light-emitting diode array can therefore illuminate the area at which the camera is directed. Consequently, the light-emitting diode array can affect the lighting conditions in this area. The light-emitting diode array comprises a plurality of individually controllable light-emitting diodes. According to the invention, it is provided that the light-emitting diode array is controlled according to a control instruction in such a way that the light-emitting diode array at least temporarily assumes a lighting state in which the brightness of at least a first light-emitting diode of the light-emitting diodes differs from the brightness of at least a second light-emitting diode of the light-emitting diodes.

The proposed method has the advantage that the functional scope of the light-emitting diode array can be extended. By controlling the device according to the invention, the light-emitting diode array can be used to display graphics, information or other things, in addition to its actual function of illuminating the capture area. This allows the user to customize the photo booth and thus improves the user experience.

The term “lighting state” used herein refers to a state of the light-emitting diode array that is visually perceptible by a person. It should be noted that light-emitting diode arrays are often controlled by a so-called multiplexing process. In a multiplexing process, only one row or one column of the light-emitting diode array is active at any given time. However, the alternating frequency with which individual rows or columns are switched is so high in a multiplexing process that the activation of individual rows or columns is not visually perceptible by a person. This alternating frequency is typically at least 50 Hz per row or 50 Hz per column. Consequently, these are not lighting states of the light-emitting diode array within the sense of the disclosure.

The brightness of a light-emitting diode is the intensity with which the light-emitting diode emits light.

In some embodiments, the light-emitting diodes of the light-emitting diode array are identical in construction. Preferably, the light-emitting diodes of the light-emitting diode array are white light-emitting diodes. The light-emitting diode array is thus an array of white light-emitting diodes. White light-emitting diodes are particularly suitable for the desired illumination of the capture area.

In some embodiments, the at least one first light-emitting diode or the at least one second light-emitting diode is switched off in the lighting state, the at least one other light-emitting diode, i.e., the at least one second light-emitting diode or the at least one first light-emitting diode, then being switched on. This creates a particularly strong brightness contrast between the light-emitting diodes.

In some other embodiments, both the at least one first light-emitting diode and the at least one second light-emitting diode are switched on in the lighting state. In these embodiments, both the at least one first light-emitting diode and the at least one second light-emitting diode emit light in the lighting state, but with different intensities.

In some preferred embodiments, it is provided that in the lighting state the brightness of at least a third light-emitting diode of the light-emitting diodes differs from the brightness of the at least one first light-emitting diode and from the brightness of the at least one second light-emitting diode. In the lighting state, there are at least three different brightnesses or light intensities. This further increases the design options with regard to individualizing the display of the light-emitting diode array. Different brightnesses or light intensities can be achieved through control technology, for example, by changing the duty cycles.

In some preferred embodiments, it is provided that, in the lighting state, a plurality of first light-emitting diodes, i.e., light-emitting diodes with a first brightness, and/or a plurality of second light-emitting diodes, i.e., light-emitting diodes with a second brightness deviating from the first brightness, are present. This makes it possible to display even complex structures using the light-emitting diode array. In addition, one or more third light-emitting diodes, i.e., light-emitting diodes with a third brightness that differs from the first brightness and the second brightness, may also be present.

Preferably, the light-emitting diode array comprises a plurality of rows of light-emitting diodes and/or a plurality of columns of light-emitting diodes. Each row of light-emitting diodes can then be controlled by a respectively different control unit. Alternatively, each column of light-emitting diodes can be controlled by a respectively different control unit. The use of a respective control unit for each row or column has the advantage that only low heat development can be achieved during operation. In particular, an energy-intensive multiplexing process can be avoided, which would be associated with a comparatively high heat development. Preferably, the control units are each designed as multi-channel light-emitting diode drivers. The light-emitting diode drivers can, for example, each have 16 channels. The use of control units of the type TLC59116 (sold under this name by Texas Instruments Incorporated) has proven to be particularly advantageous. Preferably, the control units control the individual light-emitting diodes using pulse width modulation. This allows precise adjustment of the brightness of the light-emitting diodes.

In some preferred embodiments, it is provided that the control instruction is generated by a main control unit, the main control unit providing the control instruction to the control units. In addition to the control units, there is also the main control unit. Preferably, the main control unit is designed as a microcontroller. A microcontroller is particularly suitable for complex calculations such as generating the control instruction. The main control unit can provide the complete control instruction to the control units in each case. Preferably, however, the main control unit provides each of the control units only with the part of the control instruction relevant to the control unit, in each case.

In some preferred embodiments, it is provided that the light-emitting diode array is controlled according to the control instruction in such a way that the light-emitting diode array assumes a plurality of lighting states which differ from one another in temporal sequence. Consequently, at least one light-emitting diode is a first light-emitting diode in one lighting state and a second light-emitting diode in another lighting state. In this case, the lighting states refer to states of the light-emitting diode array that can be visually perceived by a person, as previously explained. The display of different lighting states in temporal sequence has the advantage that the light-emitting diode array can also display moving structures.

In some preferred embodiments, it is provided that the light-emitting diode array changes the lighting states with an alternating frequency of at most 10 Hz. This is slow enough that people do not find the change in lighting states unpleasant. Preferably, the alternating frequency is at most 5 Hz.

In some preferred embodiments, it is provided that the control instruction is generated depending on a lighting specification that can be provided by a user. By providing the lighting specification, the user of the photo booth can specify which lighting state or states the light-emitting diode array should assume. The lighting state or states are therefore subject to influence by the user. For example, the lighting specification can be provided via a human-machine interface, in particular a touch display, of the photo booth.

In some preferred embodiments, it is provided that the lighting specification comprises at least one symbol and/or at least one character. The lighting specification can comprise a plurality of symbols in the sense of a symbol sequence. Depending on the complexity of the light-emitting diode array, the symbol sequence can be, for example, a film sequence or an animated GIF (graphics interchange format). The lighting specification can also comprise a plurality of characters in the sense of a character sequence. The light-emitting diode array is preferably controlled in such a way that it displays the at least one symbol and/or the at least one character. If the lighting specification comprises a character sequence, the light-emitting diode array can be controlled in such a way that it displays the character sequence as a scrolling text. This allows even long character sequences to be displayed using a light-emitting diode array with comparatively few light-emitting diodes. If the light-emitting diode array displays the character sequence as a scrolling text, the scrolling text is preferably generated by the light-emitting diode array assuming a plurality of lighting states in temporal sequence that differ from one another.

In some preferred embodiments, it is provided that the camera is controlled to capture at least one image in response to a photography request that can be provided by a user. Various embodiments are conceivable with regard to the provision of the photography request. For example, the photography request can be provided by means of the previously mentioned touch display. Preferably, the photo booth comprises a remote shutter release, in which case the photography request can be provided by means of the remote shutter release.

In some preferred embodiments, it is provided that the light-emitting diode array is controlled in response to the photography request in such a way that a brightness generated by the light-emitting diode array is increased for the duration of the image capture. In the lighting state in which the brightness of the at least one first light-emitting diode differs from the brightness of the at least one second light-emitting diode, the illumination of the capture area may not be optimal for image capture. Therefore, it is desirable that the brightness of the light-emitting diode array be increased for the duration of the image capture. The increase in response to the photography request has the advantage that additional input from the user is not necessary specifically for increasing the brightness of the light-emitting diode array. This contributes to a high level of user comfort. Preferably, the brightness of the light-emitting diode array is reduced after the image has been captured. The reduction in brightness following image capture can also occur with a time delay. For example, the brightness is only reduced after a timer has elapsed.

Preferably, the photo booth is operated in standby mode in the absence of a photography request. In standby mode, the light-emitting diode array is controlled in accordance with the lighting specification provided. If the photography request is provided, the photo booth is switched from standby mode to photography mode. In photography mode, the light-emitting diode array is controlled in such a way that the brightness produced by the light-emitting diode array is increased for the duration of the image capture compared to the brightness in standby mode.

In some preferred embodiments, the light-emitting diode array comprises a group of selected light-emitting diodes, and the brightness produced is increased by switching on the selected light-emitting diodes for the duration of the image capture, regardless of the lighting specification. This ensures sufficient brightness during image capture.

In some embodiments, the group of selected light-emitting diodes comprises all of the light-emitting diodes of the light-emitting diode array. Consequently, all light-emitting diodes in the light-emitting diode array are switched on for the duration of the image capture.

In some other embodiments, the group of selected light-emitting diodes comprises only a portion of the light-emitting diodes of the light-emitting diode array. At least one light-emitting diode, preferably a plurality of light-emitting diodes, are therefore not part of the group of selected light-emitting diodes. This has the advantage that the light-emitting diode array can continue to be individualized by the provided lighting specification even for the duration of the image capture. By appropriately choosing the group of selected light-emitting diodes, sufficient lighting can still be ensured. In some preferred embodiments, it is provided that the group of selected light-emitting diodes is formed by a top row and/or by a bottom row of the light-emitting diode array.

According to the invention, a photo booth with the features of claim 13 is also provided.

The photo booth according to the invention comprises a housing in which a camera is arranged. The camera is directed at a capture area outside the housing. The photo booth also comprises a light-emitting diode array which is arranged on or in the housing such that the capture area can be illuminated by the light-emitting diode array, wherein the light-emitting diode array comprises a plurality of individually controllable light-emitting diodes. The photo booth also comprises a control device which is designed to carry out the method described above.

The control device is thus designed to control the light-emitting diode array according to a control instruction such that the light-emitting diode array at least temporarily assumes a lighting state in which the brightness of at least a first light-emitting diode of the light-emitting diodes differs from the brightness of at least a second light-emitting diode of the light-emitting diodes.

Advantages and possible developments of the photo booth are to be understood as also being described in relation to the method and, vice versa, advantages and possible developments of the method are to be understood as also being described in relation to the photo booth.

Preferably, the control device for controlling the light-emitting diode array comprises at least one control unit. A plurality of control units can also be provided.

Preferably, the control device is arranged in the housing of the photo booth.

Preferably, the control device comprises a computer-readable, non-volatile data memory on which a computer program is stored which comprises instructions which cause the control device to carry out the method described above.

In some embodiments, the photo booth comprises a stand attached to the housing.

In some embodiments, the light-emitting diodes of the light-emitting diode array are identical in construction. Preferably, the light-emitting diodes of the light-emitting diode array are white light-emitting diodes. The light-emitting diode array is thus an array of white light-emitting diodes. White light-emitting diodes are particularly suitable for the desired illumination of the capture area.

In some embodiments, the camera is a USB camera, a system camera, an industrial camera, or a compact camera. A USB camera in conjunction with a photo booth has the advantage that it generates little heat during operation. Low heat development is particularly advantageous in a photo booth because the camera is arranged in the housing, which makes it difficult for heat to dissipate. The use of a USB camera as a camera is therefore particularly preferred.

In some embodiments, the light-emitting diode array is arranged on the housing. For example, the light-emitting diode array is an add-on part and is detachably attached to the housing.

In some other embodiments, the light-emitting diode array is arranged in the housing. The camera and the light-emitting diode array can be directed at the capture area through the same opening in the housing. Preferably, however, the housing comprises a first opening through which the camera is directed towards the capture area, and a second opening through which the light-emitting diode array is directed towards the capture area.

Preferably, the light-emitting diode array comprises at least 40 light-emitting diodes. This allows the lighting state of the light-emitting diode array to be highly individualized.

In some preferred embodiments, the light-emitting diode array comprises multiple rows of light-emitting diodes and/or multiple columns of light-emitting diodes. The light-emitting diode array can, for example, comprise 5 rows of 16 light-emitting diodes each (i.e., 16 columns of 5 light-emitting diodes each). Preferably, each of the rows can be controlled by a respectively different control unit of the control device. Each row of the light-emitting diode array is therefore assigned to a respectively different control unit of the control device. This allows a particularly precise adjustment of the control of the light-emitting diodes. Alternatively, each of the columns can be controlled by a respectively different control unit of the control device. Preferably, the control units are each designed as a multi-channel light-emitting diode driver. The light-emitting diode drivers can, for example, each have 16 channels. The use of control units of the type TLC59116 (sold under this name by Texas Instruments Incorporated) has proven to be particularly advantageous. Preferably, the control units control the individual light-emitting diodes using pulse width modulation. This allows precise adjustment of the brightness of the light-emitting diodes.

In some embodiments, the control units are communicatively connected to the light-emitting diode array via a data bus. The data bus can, for example, be an I²C data bus.

In some preferred embodiments, it is provided that the photo booth comprises a main control unit which is communicatively connected to the control units. The main control unit is configured to generate the control instruction and to provide the generated control instruction to the control units. Preferably, the main control unit is designed as a microcontroller. A microcontroller is particularly suitable for complex calculations such as generating control instructions. The main control unit can provide the complete control instruction to the control units in each case. Preferably, however, the main control unit provides each of the control units only with the part of the control instruction relevant to the corresponding control unit.

In some embodiments, the photo booth comprises a human-machine interface for providing a lighting specification by a user. Particularly preferably, the human-machine interface is designed as a touch display. Such a touch display can realize additional functions of the photo booth in addition to providing the lighting specification. For example, images captured by the camera can be displayed on the touch display. Preferably, the touch display is arranged in a third opening of the housing.

In some embodiments, the first opening, the second opening, and the third opening are formed in the same wall portion of the housing. This wall portion can be the front wall of the housing.

In some embodiments, the photo booth comprises a remote shutter release for providing a photography request by the user.

In some preferred embodiments, it is provided that the housing comprises a wall portion made of a metal material. The wall portion made of the metal material can, for example, be a rear cover of the housing. Preferably the metal material is aluminum. Preferably, the control device, the camera and/or the light-emitting diode array are in heat-conducting contact with the wall portion. The wall portion can therefore serve as a heat sink for these components of the photo booth. For example, one or more circuit boards of the photo booth are arranged on the wall portion.

In some embodiments, the housing comprises a deep-drawn part made of plastics material. Particularly preferably, the housing comprises both the deep-drawn part made of plastics material and the wall portion made of the metal material. For example, the wall portion is inserted into a recess in the deep-drawn part.

In the following, the invention will be explained in more detail on the basis of the drawings. In the drawings:

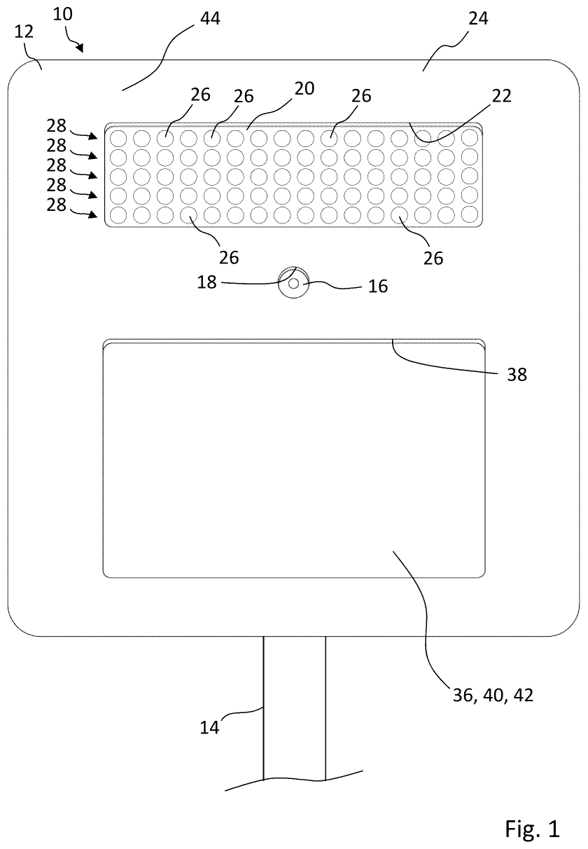

FIG. 1 is a front view of a photo booth according to an exemplary embodiment;

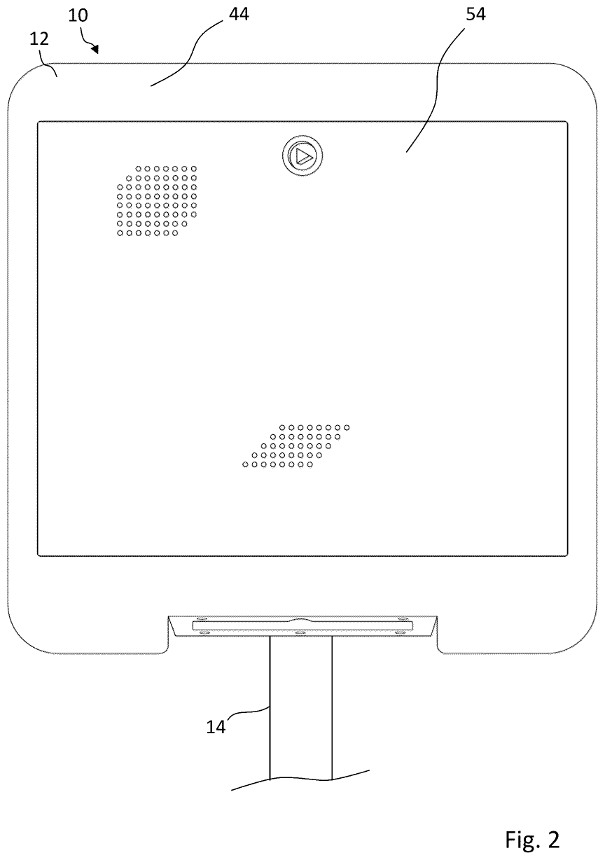

FIG. 2 is a rear view of the photo booth shown in FIG. 1;

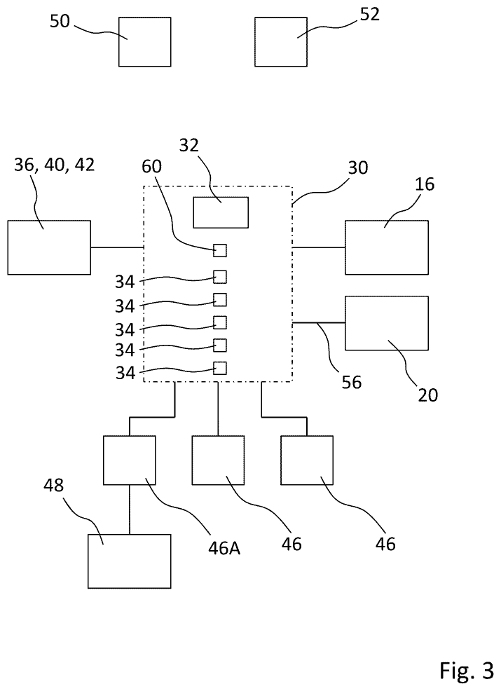

FIG. 3 is a schematic view of components of the photo booth shown in FIGS. 1 and 2;

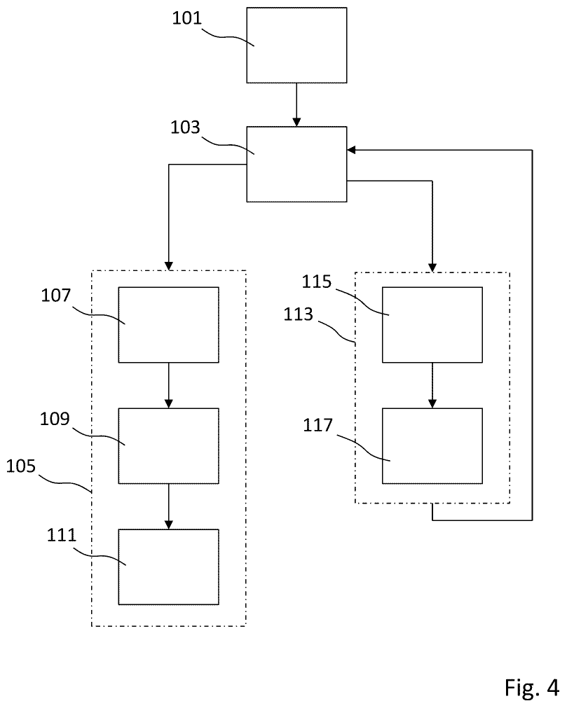

FIG. 4 shows a method for operating the photo booth; and

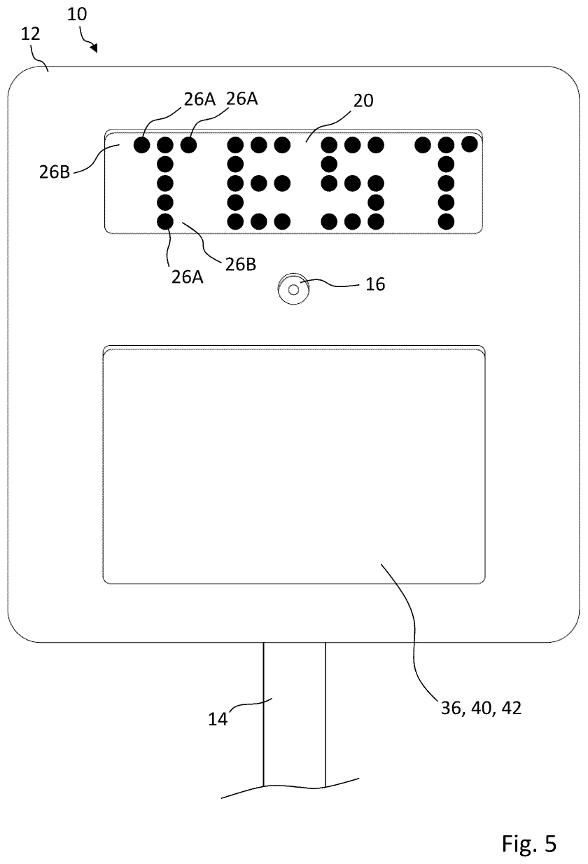

FIG. 5 is a further view of the photo booth.

FIGS. 1 and 2 show a photo booth 10. FIG. 3 is a functional diagram of components of the photo booth 10. Not all components shown schematically in FIG. 3 are visible in FIGS. 1 and 2.

The photo booth 10 comprises a housing 12. In the present case, the housing 12 comprises a deep-drawn part 44, i.e., a component manufactured by deep drawing. The deep-drawn part 44 is made of a plastics material, preferably acrylonitrile-butadiene-styrene copolymer (ABS). Preferably, at least one flame-retardant substance is added to the plastics material.

The photo booth 10 is intended for freestanding use. In the present case, the housing 12 of the photo booth 10 is attached to a tripod 14. Preferably, the housing 12 is detachably attached to the tripod 14.

The photo booth 10 comprises a camera 16 which is arranged in the housing 12. The camera 16 is directed at a capture area outside the housing 12, in this case through a first opening 18 formed in the housing 12. Preferably, the camera 16 is designed as a USB camera. The camera 16 can also be designed as a compact camera, an industrial camera or a system camera.

The photo booth 10 also comprises a light-emitting diode array 20. The light-emitting diode array 20 is directed towards the capture area of the camera 16. Consequently, the light-emitting diode array 20 is designed to illuminate the capture area.

In the present case, the light-emitting diode array 20 is arranged in the housing 12 and directed towards the capture area through a second opening 22 formed in the housing 12. In this case, the first opening 18 and the second opening 22 are formed in a front wall 24 of the housing 12. According to a further embodiment, the light-emitting diode array 20 is arranged on the housing 12. The light-emitting diode array 20 can, for example, be designed as an add-on part and detachably attached to the housing 12.

The light-emitting diode array 20 comprises a plurality of individually controllable light-emitting diodes 26. Each individual light-emitting diode 26 can therefore be specifically controlled and thereby switched on without switching on the other light-emitting diodes 26. Preferably, the light-emitting diodes 26 are of identical design. These are light-emitting diodes 26 of the same type. Preferably, the light-emitting diodes 26 are white light-emitting diodes 26.

In the present case, the light-emitting diode array 20 comprises five rows 28 with 16 light-emitting diodes 26 each. Consequently, there are a total of 80 light-emitting diodes 26. This number and arrangement of light-emitting diodes 26 is preferred. However, the light-emitting diode array 20 can also have a different number of light-emitting diodes 26.

The photo booth 10 also comprises a control device 30. The control device 30 is arranged in the housing 12 and is not visible in FIG. 1.

The control device 30 is designed to control the light-emitting diode array 20. For this purpose, the control device 30 is connected communicatively to the light-emitting diode array 20 via a data bus 56. The control device 30 comprises at least one control unit 34 for controlling the light-emitting diode array 20. In the present case, there are five control units 34. Each of the control units 34 is designed to control a different row 28 of light-emitting diodes 26. In the present embodiment, the control units 34 are 16-channel light-emitting diode drivers 34.

The control device 30 also comprises a main control unit 60. The main control unit 60 is connected to the control units 34 communicatively. In the present embodiment, the main control unit 60 is a microcontroller.

The control device 30 is also connected to the camera 16 communicatively and is designed to control the camera 16. For this purpose, the control device 30 can comprise a further control unit.

The control device 30 also comprises a computer-readable, non-volatile data memory 32. A computer program is stored on the data memory 32, which comprises instructions that cause the photo booth 10 to carry out the method that will be explained in more detail later with reference to FIG. 4. At least the main control unit 60 is communicatively connected to the data memory 32 so that the main control unit 60 can call up the computer program.

The photo booth 10 also comprises a touch display 36. The touch display 36 is arranged in a third opening 38 of the front wall 24 of the housing 12. The touch display 36 is also communicatively connected to the control device 30. The touch display 36 can be operated by a user of the photo booth 10 and thus forms a human-machine interface 40 of the photo booth 10. Preferably, images captured by the camera 16 can be displayed on the touch display 36, so that the touch display 36 also forms a display unit 42 of the photo booth 10.

In the embodiment shown, the photo booth 10 also comprises a plurality of connections 46. In the present case, the connections 46 are designed as USB connections. The connections 46 are connected to the control device 30 communicatively.

The photo booth 10 also comprises a remote shutter release 48. The remote shutter release 48 is connected to a first connection 46A of the connections 46.

The remaining connections 46 can be used to connect various devices. For example, a printer or a data memory device can be connected to the connections 46.

The photo booth 10 also comprises a power input 50. In the present case, the power input 50 is a 24V DC input. An external power supply unit can be connected to the power input 50. The various components of the photo booth 10, in particular the camera 16, the light-emitting diode array 20, the control device 30 and the connections 46, are electrically connected to the power input 50. For the sake of clarity, the electrical connections between the power input 50 and these components are not shown in FIG. 3.

The photo booth 10 also comprises a power output 52 which is electrically connected to the power input 50. In the present case, the power output 52 is a 24V DC output. For example, the previously mentioned printer can be connected to the power output 52.

In the present case, the housing 12 comprises a wall portion 54 which is made of a metal material, in particular aluminum. In the embodiment shown, the wall portion 54 is a rear cover of the housing 12 (see FIG. 2). The wall portion 54 can serve as a heat sink for electrical components of the photo booth 10. Preferably, the control device 30, the camera 16 and/or the light-emitting diode array 20 are in heat-conducting contact with the wall portion 54.

In the following, an advantageous method for operating the photo booth 10 is explained in more detail with additional reference to FIGS. 4 and 5. FIG. 4 shows the method using a flow chart.

In a first step 101, the photo booth 10 is put into operation. This is done, for example, by electrically connecting the power input 50 to a power supply unit. Alternatively, it can also be brought into operation by first operating a switch or similar.

In a second step 103, the control device 30 checks whether a photography request that can be provided by a user is present. The user can provide the photography request for example by operating the remote shutter release 48.

If there is no photography request, the photo booth 10 is put into a standby mode 105. However, the control device 30 continues to check whether the photography request is present.

In the standby mode 105, the control device 30 checks, in a third step 107, whether a lighting specification for the light-emitting diode array 20 that can be provided by a user is present. The user can provide the lighting specification for example via the human-machine interface 40. By way of the lighting specification, the user specifies how the light-emitting diode array 20 should light up in the standby mode 105. For example, the lighting specification may comprise a character sequence to be displayed by the light-emitting diode array 20. Purely by way of example, it is assumed below that the character sequence “TEST” is provided as the lighting specification. The light-emitting diode array 20 should therefore display the character sequence “TEST” in standby mode 105. Of course, the lighting specification can also comprise a different character string. It is also possible that no characters are specified as the lighting specification, but rather, deviating therefrom, symbols. In particular, a list of possible lighting specifications from which the user can select is stored in the data memory 32.

If there is no lighting specification, the light-emitting diode array 20 is not activated in the standby mode 105.

However, if a lighting specification is present, reference is made to a fourth step 109. In the fourth step 109, the control device 30 generates a control instruction depending on the lighting specification provided. The control instruction is generated in such a way that, when the light-emitting diode array 20 is controlled according to the control instruction, the lighting specification is represented by the light-emitting diode array 20.

In the present embodiment, the control instruction is generated by the main control unit 60. The main control unit 60 then provides the control instruction or only the part of the control instruction relevant to the control units 34.

Alternatively, the control instruction can also be generated by the control units 34 themselves, wherein preferably each of the control units 34 generates only the part of the control instruction that is relevant to it.

In a fifth step 111, the control units 34 control the light-emitting diode array 20 according to the control instruction. Depending on the lighting specification, the light-emitting diode array 20 then assumes a different lighting state. In the present example, the light-emitting diode array 20 is controlled such that it assumes a lighting state in which it displays the character sequence “TEST” (see FIG. 5). The character sequence is displayed by actuating or switching on only one group of first light-emitting diodes 26A. A group of second light-emitting diodes 26B is not actuated and thus remains switched off. Consequently, in the lighting state, the first light-emitting diodes 26A have a different brightness than the second light-emitting diodes 26B. Alternatively, the second light-emitting diodes 26B can also be controlled such that they emit light with a lower intensity than the first light-emitting diodes 26A. This also leads to a difference in brightness.

In the present example, the character sequence is so short that it can be represented as such in a single lighting state by the light-emitting diode array 20. If the lighting specification comprises a longer character sequence, the control instruction can be generated such that the light-emitting diode array 20 displays the character sequence as a scrolling text. The light-emitting diode array 20 then assumes various lighting states in temporal sequence, which differ from one another.

If the control device 30 determines, in the second step 103 or during the standby mode 105, that the photography request is present, the photo booth 10 is put into a photography mode 113.

The representation of the lighting specification by the light-emitting diode array 20 sometimes does not result in sufficient illumination of the capture area. The light-emitting diode array 20 is therefore controlled, in a sixth step 115, within the scope of the photography mode 113, such that the brightness of the light-emitting diode array 20 is increased compared to the representation of the lighting specification. For example, for this purpose the light-emitting diode array 20 is controlled in such a way that all light-emitting diodes 26 are switched on.

In a seventh step 117, the control device 30 then controls the camera 16 such that the camera 16 captures at least one image. The camera 16 can also be controlled to capture a sequence of images.

After the image has been captured, the photo booth 10 can be put back into standby mode 105. For example, a timer is started when the image capture is completed, and the photo booth 10 is returned to standby mode 105 after the timer has expired. For example, the timer can be 10 seconds.

1. A method for operating a portable photo booth, wherein the portable photo booth comprises
a housing,
a camera, or a USB camera, or a system camera, or an industrial camera or a compact camera, which is arranged in the housing and directed towards a capture area outside the housing, and
a light-emitting diode array which is arranged in or on the housing such that the capture area can be illuminated by the light-emitting diode array, wherein the light-emitting diode array comprises a plurality of individually controllable light-emitting diodes, wherein:
the light-emitting diode array is controlled according to a control instruction in such a way that the light-emitting diode array at least temporarily assumes a lighting state in which the brightness of at least one first light-emitting diode of the light-emitting diodes differs from the brightness of at least one second light-emitting diode of the light-emitting diodes.

2. The method according to claim 1, wherein, in the lighting state the brightness of at least one third light-emitting diode of the light-emitting diodes differs from the brightness of the at least one first light-emitting diode and from the brightness of the at least one second light-emitting diode.

3. The method according to claim 1, wherein, in the lighting state a plurality of first light-emitting diodes and/or a plurality of second light-emitting diodes are present.

4. The method according to claim 1, wherein the light-emitting diode array comprises a plurality of rows of light-emitting diodes, each row being controlled by a respectively different control unit, or in that the light-emitting diode array comprises a plurality of columns of light-emitting diodes, each column being controlled by a respectively different control unit.

5. The method according to claim 4, wherein the control instruction is generated by a main control unit, or a microprocessor, the main control unit providing the control instruction to the control units.

6. The method according to claim 1, wherein the light-emitting diode array is controlled according to the control instruction in such a way that the light-emitting diode array assumes a plurality of lighting states which differ from one another in temporal sequence.

7. The method according to claim 6, wherein the light-emitting diode array changes the lighting states with an alternating frequency of at most 10 Hz, or at most 5 Hz.

8. The method according to claim 1, wherein the control instruction is generated depending on a lighting specification that can be provided by a user.

9. The method according to claim 8, wherein the lighting specification comprises at least one symbol and/or at least one character, or a character sequence, and in that the light-emitting diode array is controlled in such a way that the light-emitting diode array displays the at least one symbol and/or the at least one character, or the character sequence, or as a scrolling text.

10. The method according to claim 1, wherein the camera is controlled to capture at least one image in response to a photography request that can be provided by a user.

11. The method according to claim 10, wherein the light-emitting diode array is controlled in response to the photography request in such a way that a brightness generated by the light-emitting diode array is increased for the duration of the image capture.

12. The method according to claim 11, wherein the light-emitting diode array comprises a group of selected light-emitting diodes, and in that the brightness generated is increased by switching on the selected light-emitting diodes for the duration of the image capture independently of the lighting specification.

13. A portable photo booth, comprising:
a housing,
a camera, or a USB camera, or a system camera, or an industrial camera or a compact camera, which is arranged in the housing and directed towards a capture area outside the housing,
a light-emitting diode array which is arranged on or in the housing such that the capture area can be illuminated by the light-emitting diode array, wherein the light-emitting diode array comprises a plurality of individually controllable light-emitting diodes, or at least 40 individually controllable light-emitting diodes, and
a control device which is designed to carry out the method according to claim 1.

14. The portable photo booth according to claim 13, wherein the light-emitting diode array comprises a plurality of rows of light-emitting diodes, each row being controllable by a respectively different control unit of the control device, or in that the light-emitting diode array comprises a plurality of columns of light-emitting diodes, each column being controllable by a respectively different control unit of the control device.

15. The portable photo booth according to claim 13, wherein the housing comprises a wall portion made of a metal material, or aluminum, the control device, the camera and/or the light-emitting diode array being in heat-conducting contact with the wall portion.
